(19) United States
(12) Patent Application Publication
(10) Pub. No.: US 2006/0148651 A1
(43) Pub. Date: Jul. 6, 2006

(54) Methods and products to protect against root intrusion and plant and root growth

(75) Inventors: Edward S. Lipinsky, Worthington, OH (US); Dominic A. Cataldo, Kennewick, WA (US); Peter Van Voris, Daniel Island, SC (US)

Correspondence Address: MUELLER AND SMITH, LPA;MUELLER-SMITH BUILDING, 7700 RIVERS EDGE DRIVE, COLUMBUS, OH, 43235, US

(73) Assignee: GrowGuard, LLC, Inc.

(21) Appl. No.: 11/364,247

(22) Filed: Feb. 28, 2006

Related U.S. Application Data
(63) Continuation-in-part of application No. 10/438,559, filed on May 15, 2003, now Pat. No. 7,012,042.
(63) Continuation-in-part of application No. 10/438,584, filed on May 15, 2003.
(63) Continuation-in-part of application No. 10/889,956, filed on Jul. 13, 2004.
(60) Provisional application No. 60/380,584, filed on May 15, 2002.

(51) Int. Cl. A01N 33/18; A01N 25/28

(52) U.S. Cl. 504/347; 504/359; 977/900

(57) ABSTRACT

This invention provides repellent devices and methods for control of root intrusion and plant growth. One aspect of this invention is a geotextile in which 2,6-dinitroaniline is stored inside the individual filaments. The 2,6-dinitroaniline is stored in nanoclay or smectite clay reservoirs that control the rate of release of the 2,6-dinitroaniline. These reservoir particles are placed in the fibers during the melt spinning production of the fibers or by film-to-fiber processes. The particles are very thin and are oriented within the fibers during the spinning process. These clay reservoirs are superior to conventional carbon-based reservoirs, because the dispersed clay materials have a uniform, e.g., 1-nanometer, thickness that is needed to fit into individual filaments. Nonwoven, woven, or knitting processes are used to make the geotextile fabrics. The fibers of this invention prevent root intrusion into these fabrics.

### CROSS-REFERENCE TO RELATED APPLICATIONS

This application is a continuation-in-part of application Ser. No. 10/438,559, filed May 15, 2003, which claims benefit of provisional application Ser. No. 60/380,584, filed May 15, 2002; and is cross-referenced to application Ser. No. 10/816,095, filed Apr. 1, 2004; the disclosures of which are expressly incorporated herein by reference.

### STATEMENT REGARDING FEDERALLY SPONSORED RESEARCH

Not applicable.

### FIELD OF THE INVENTION

This invention is directed to the field of nanoparticle-filled fibers, fabrics, and coatings for prevention of root intrusion and control of plant growth via controlled sustained release of a bioactive agent.

### BACKGROUND OF THE INVENTION

There is considerable patent and technical literature concerning polymeric fibers that contain solid particulates within the fibers. Examples include inclusion of small amounts of titanium dioxide in polyester fibers as a delustrant and use of silicon dioxide particles to enhance the gloss of polyester fibers. Magnetic fibers have been reported that are thermoplastic fibers loaded with cobalt alloys. A recent patent in this area (U.S. Pat. No. 6,723,378) makes use of void volume associated with porous fiber strands and/or voids that exist between a multiplicity of single fiber strand that are twisted to form a fiber. U.S. Pat. No 6,127,028 uses melt spinning of mixtures of molten thermoplastics with finely divided metals or metal oxides to produce cut resistant fabrics. None of this prior art pertains to desorption and diffusion processes.

U.S. Pat. No. 6,607,994 does pertain to controlled release using nanoparticle-based permanent treatments for textiles; however, the particles cling to the outside of the fibers and require a covalent bond between the fiber and the nanoparticle.

U.S. Patent Application 20030092817 describes pesticide formulations in which the active ingredient is sorbed into carbon black and a nanoclay is employed to increase the tortuosity of the diffusion path of the pesticide in its transport from the carbon black carrier to the environment.

U.S. patent application Ser. No. 10/816,095 (cited above) does provide a technology for making the nanoparticles needed for this invention and is incorporated into this application by reference. In it, intercalation of a 2,6-dinitroaniline into montmorillonite and/or a nanoclay made from a smectite mineral is followed by exfoliation of the sorbed product in a polymer matrix or a monomer that is converted to a polymer matrix. The nanoclay that is loaded with 2,6-dinitroaniline is converted to a powder that is suitable for use in the present invention.

U.S. Pat. No. 5,421,876 proposes an organoclay-filled asphaltic polyurethane dispersion. In column 8, lines 41-44, additives are mentioned that include insecticides and fungicides. This prior art is distant from the Applicant's invention in that the additives are not sorbed onto the nanoclay, the nanoclay's role is to stabilize the asphalt dispersion. The dispersion is expected to release the additives much more rapidly than the products of the Applicant's invention.

Although U.S. patent application Ser. No. 10/816,095 provides a method for loading the active ingredient into a nanoparticle, successful use of said particles to produce fibers and fabrics that prevent root intrusion over long time periods is lacking. It is to such development that the present invention is addressed.

### BRIEF SUMMARY OF THE INVENTION

This invention provides repellent devices and methods for control of root intrusion and plant growth. One aspect of this invention is a geotextile in which 2,6-dinitroaniline (which by definition for present purposes includes a salt thereof) is stored inside the individual filaments. The 2,6-dinitroaniline is stored in nanoclay or smectite clay reservoirs that control the rate of release of the 2,6-dinitroaniline. The nanoclays are manufactured by intercalation of ammonium ion compounds between the layers of certain clays. The intercalated products are converted to exfoliated products by dispersion of the intercalated materials in a liquid medium that is usually a polymer melt of a liquid formulation that is polymerized to form a solid.

These reservoir particles are placed in the fibers during the melt spinning production of the fibers. The particles are very thin and are oriented within the fibers during the spinning process. These clay reservoirs are superior to conventional carbon-based reservoirs, because the dispersed clay materials have a uniform, e.g., 1-nanometer, thickness that is needed to fit into individual filaments. Nonwoven, woven, or knitting processes are used to make the geotextile fabrics. The fibers of this invention prevent root intrusion into these fabrics.

In a second aspect, a geotextile can contain both 2,6-dinitroaniline-loaded fibers and unfilled (non-loaded) fibers that enhance the physical properties of the geotextile and reduce its manufacturing cost. The unfilled fibers can be selected for their ability to sorb 2,6-dinitroanilines and the pattern of the geotextile can be designed such that the unfilled fibers can become secondary reservoirs for 2,6-dinitroaniline. Alternatively, a multifilament fiber can be made that includes filaments of unfilled fibers and filaments of 2,6-dinitroaniline-loaded fibers. The multifilament fibers are twisted together so that there is close contact between the two types of fibers. The multifilament fibers can be used to produce fabrics that resist root intrusion, while having enhanced mechanical properties and extended product longevity because of longer diffusion path.

In a third aspect, an improved method of applying 2,6-dinitroaniline to surfaces of geotextiles, pipes, soil, and other substrates is disclosed. This aspect employs a polyurethane or other polymer spray coating and casting method, which incorporates reinforcement (filler) fibers loaded with a 2,6-dinitroaniline-loaded nanoclay in the polyurethane elastomer or other polymeric system.

In a fourth aspect, short filaments of 2,6-dinitroaniline-loaded nanoclay particles that are inside staple fibers are used as fluff. This fluff can be used to supply 2,6-dinitroaniline in multi-ply geotextiles. The fluff can be held in place by needle punching of two nonwoven webs that have the fluff trapped between them.

In a fifth aspect, a formulation of a polymer gel for one or more of repairing pipe, a grout for pipe, or a soil stabilizer, the improvement for one or more of root intrusion or root growth when said coated pipe is placed underground, is achieved by incorporating into the formulation, fibers loaded with a 2,6-dinitroaniline-loaded nanoclay.

In each of the above-described aspects, the color of the product is adjusted to meet design specifications for the intended application. Usually, the chosen color will be black or green or brown.

### DETAILED DESCRIPTION OF THE INVENTION

Loaded Melt Spun Fibers

The major cornerstone of the fiber aspect of this invention is the method by which 2,6-dinitroaniline-loaded nanoparticles can be embedded successfully in melt spun fibers. The method must meet stringent criteria: the spinnerettes must not be clogged by the particles, which means that the size and size distribution of the particles must be controlled to specified limits. The particles must not agglomerate to a size that would cause clogging. The particles must retain most of the 2,6-dinitroaniline at temperatures above 120° C. that are used for spinning. The particles must have a high holding capacity for the active ingredient, and they must release the active ingredient slowly. The polymer must melt at a temperature that is below the degradation temperature of the active ingredient or a means to circumvent this limitation must be found. In addition, interaction of the particles with the polymer must not increase the viscosity of the spinning fluid beyond the limits imposed by the melt spinning process. The strength and other mechanical properties of the loaded fiber must be adequate to meet the requirements of rugged geotextile products. These parameters have been defined, based on the experiments reported herein.

An alternative to melt spinning is film-to-fiber formation processes, which involve extrusion of a thermoplastic film or sheet. The film is slit or cut and then twisted to produce a fiber. Some film-to-fiber processes use chemomechanical fibrillation to make fibers directly from the film.

The preferred 2,6-dinitroanilines include, but are not limited to one or more of trifluralin, oryzalin, pendimethalin, isopropalin, diniramine, fluchloralin, benefin, or dinoseb.

The preferred clays include, but are not limited to, one or more of smectite, montmorillonite, beidellite, nonttronite, saponite, or sauconite. For present purposes, minerals with a high percentage (e.g., greater than about 70%) of smectite or other clay, such as, for example, bentonite (about 88% montmorillonite), are included within the definition of “clays”. The preferred nanoclays are those that are derived from the aforementioned clays by reaction with onium salts, especially ammonium salts, including, for example, Nanomers from Nanocor, Inc. and Closites from Southern Clay products, such as:
Nanomer I.30E (70%-75% Montmorillonite; 25%-30% protonated octadecylamine;
Nanomer I.30P (70%-75% Montmorillonite; 25%-30% protonated octadecylamine;
Nanomer I.34TCN (65%-80% Montmorillonite; 20%-35% methyl tallow bis(2-hydroxyethyl)ammonium salt;
Nanomer I.44PA (77% Montmorillonite; 23%-30% dimethyl dialkyl [C14-C18] Ammonium salt;
Nanomer PGV (100% Montmorillonite);
Closite 10A benzyldimethyl hydrogenated tallow ammonium chloride;
Closite 30 B methyl, tallow, bis-2-hydroxyethyl, quaternary ammonium chloride.

The preferred polymers for melt spinning for fiber production in this invention include, but are not limited to, one or more of the following thermoplastics: polypropylene, polyethylene, ethylene/propylene copolymers, polyethylene terephthalate, polytrimethylene terephthalate, polyamides, polycaprolactone, polylactic acid, lactic acid-glycolic acid polyesters, or poly(3-hydroxy butyrate). The same polymers are preferred for the film-to-fiber processes. Fibers made from these thermoplastics are “filled” by including a 2,6-dinitroaniliine-loaded clay or nanoclay in the thermoplastic melt that is formed into the fibers either by melt-spinning or by film-to-fiber processes.

Fabrics From Loaded Melt Spun Fibers

The second aspect of this invention pertains to nonwoven and woven fabrics that contain the 2,6-dinitroaniline-loaded fibers described in the first aspect. The output of the melt spinning process can be spun-bonded nonwoven fabrics in which fabric production is integrated with fiber production. Alternatively, staple fibers can be made via melt spinning, followed by chopping into lengths that are suitable for the application. The staple fibers then can be processed into nonwoven or woven fabrics that will prevent root intrusion. The novelty of these products arises from the novel loaded fiber and also from the blending of strong unfilled fibers with the weaker loaded fibers and the processing to achieve the end use requirements of geotextile markets. In addition, 2,6-dinitroaniline can be transferred from the initial fibers to unfilled fibers in the nonwoven or woven product while the product is in use. Some end uses benefit from formation of a multifilament fiber for use in the geotextile. Other end uses benefit from combinations of unfilled fibers and 2,6-dinitroaniline-loaded fibers.

The preferred unfilled fibers that are melt spun have been listed above. Those that are not melt spun (that is, biosynthesized or dry spun or wet spun) and that are blended with chopped melt spun fibers include, but are not limited to, one or more of the following natural polymers: cotton, rayon, cellulose pulp, flax, jute, hemp, or wool. Synthetic polymers that are candidates for use as unfilled fibers include, for example, one or more of cellulose acetate, vinyls, or acrylics.

Spray Urethanes With Loaded Nanoclay Fibers

The third aspect of this invention is the use of the 2,6-dinitroaniline-loaded clay fiber particles in coating formulations, especially spray formulations. Spray nozzles are not as sensitive as spinnerettes are, but clogging can be a problem in this method of application. Therefore, the use of thin, orientable nanoparticles in this application is highly desirable. The combination of high holding capacity and slow release renders the nanoparticles of this invention quite useful in coatings for geotextiles, sewer pipes, and plant growth regulator applications.

The 2,6-dinitroaniline -loaded nanoclay particles are melt spun with polyolefin to form a loaded, e.g., polypropylene or polyethylene continuous fiber product. This product is one of the First Aspect materials. The spraying device that uses the continuous fiber has a chopper that produces short fiber segments in the space above the mixing chamber of the sprayer. The length of the chopped fibers is about 6 mm or less. The chopped fibers are intimately mixed with the isocyanate and polyol ingredients just prior to spraying. This method is similar to that used in chopping and incorporating short glass fibers into polyurethane automobile parts. The spraying operation makes use of the adhesive properties of polyurethane to form a coating on geotextile fabrics or soil or pipes.

In another embodiment, two polymer sheets can be glued together by spraying with the above-described polyurethane adhesive that contains the fibers that are loaded with 2,6-dinitroaniline-loaded nanoclay particles. The product can be needle-punched to form a nonwoven fabric.

The third aspect also includes an improved geotextile product and process that uses powder coating or ink jet technology to make available films or sheets that have specified amounts of 2,6-dinitroaniline-loaded nanoclay fibers, optionally admixed with load nanoclay (sans fiber), spread over its area and contained at a specified depth beneath its surface. The product comprises three layers. The top and bottom layers are thermoplastic polymer sheets or films. The middle layer is a coating of 2,6-dinitroaniline-loaded nanoparticles of this invention. The layers are welded together thermally or by use of an adhesive. The product can be needle punched to form a superior geotextile to prevent root intrusion.

Moisture cure and other one-component polyurethanes also can be employed in the present invention. Moisture-cured one-component polyurethanes have been described in The Polyurethanes Book, edited by Randall and Less (pages 374 and 375 (Wiley, 2002). They are widely used in maintenance and repair in outdoor environments. Examples include coatings for bridges and sealers for concrete. These polyurethanes are based on prepolymers made by reaction of polymeric MDI, or TDI, or HDI with polyols to form roughly linear molecules. The ratio of isocyanate to polyol is adjusted so that there is an excess of isocyanate in the product. All moisture is excluded from the product, and moisture proof packaging is used.

The product is applied by airless spraying, brushing or by use of rollers. The moisture in the air and on the surface of the substrate react with the isocyanate groups to form amines that react with other isocyanate groups to form polyureas that crosslink the product. The by-product carbon dioxide can cause blisters and/or pinholes, especially in thicker coatings or moldings.

One-component polyurethanes have numerous advantages over two component systems, such as no metering, no on-site mixing, no solvents, and much relaxed OSHA and EPA safety requirements.

Loaded Staple Fibers in Multi-Ply Geotextiles

The fourth aspect of this invention uses 2,6-dinitroaniline-loaded nanoparticles that are in fibers that are sandwiched between polymer sheet layers that are converted to nonwoven products. Polyolefin staple fibers form a desorbent fluff that supplies 2,6-dinitroaniline that repels roots from intruding into a geotextile product.

The loaded staple fibers are produced by the methods described in the First Aspect of this invention. Thus, the raw materials are those described therein. The staple fibers may be purchased or continuous loaded fibers can be chopped to the desired length during manufacture of the geotextile product.

The fluff is distributed to one outer layer of the geotextile and then trapped within the structure by placing the other layer upon it. Needle punching is employed to provide holes through which water can percolate. This operation also reduces migration of the fluff within its layer.

Loaded Fiber Reinforced Acrylamide Gel Products

In this fifth aspect of the invention, a formulation of a polymer gel that contains a fibrous reinforcement provides a product for use in one or more of the following applications: repairing pipe, a grout for pipe, or a soil stabilizer. The improvement for one or more of root intrusion or root growth when said coated pipe is placed underground, is achieved by incorporating into the formulation, fibers loaded with a 2,6-dinitroaniline-loaded nanoclay.

Placement of the 2,6-dinitroaniline-loaded nanoclay within a fiber avoids partial destruction of the 2,6-dinitroaniline by free radicals that are used to initiate the polymerization and crosslinking reactions that result in the gel product. Also, the exposed 2,6-dinitroaniline in the loaded nanoclay can terminate the polymerization and crosslinking reaction free radical intermediates.

Thus, there are distinct advantages in adding fibers loaded with a 2,6-dinitroaniline-loaded nanoclay to a formulation for making acrylamide gels. The fibers to be used in this aspect of the invention include those that are fibers or continuous rolls of fiber that are chopped to the appropriate length at the site.

Preparation of 2,6-Dinitroaniiline-Loaded Nanoclay Fibrous Products

The initial step is preparation of the 2,6-dinitroaniline-loaded nanoclay reservoir by the sorption methods taught by U.S. patent application Ser. No. 10/816,095. The reservoir material can be dispersed as platelets either in liquefied monomers or polymers. The loaded monomer is polymerized to yield a loaded polymer. These two options are not necessarily equivalent because it may be preferable to exfoliate the nanoclay in a monomer that is less viscous than the molten polymer or the molten polymer may have to be at a temperature beyond 2,6-dinitroaniline's stability limit. Dispersion in the monomer is not always preferable because some monomers could react with 2,6-dinitroaniline. The reactive functional groups would not present in the polymer.

The next step can be to produce directly fibers or films or molded products from the loaded polymer. As examples: Loaded fibers can be made by melt spinning. Loaded film or sheet materials can be made by extrusion. Injection molding or casting can be used to make thicker objects. Loaded fiber production is the most challenging and is discussed below.

To meet the stringent mechanical and environmental performance requirements of geotextiles, the loaded fiber or film products usually must be modified or formulated in special ways. For example, the geotextile may use a mixture of 2,6-dinitroaniline-loaded polypropylene fibers and non-loaded polyester fibers. The percentage of each type of fiber and the location of the 2,6-dinitroaniline-loaded polypropylene fibers need to be determined.

The loaded polymer also can be used in a sprayable formulation that can circumvent manufacturing and end use problems that could arise through direct conversion of the loaded polymer into a shaped object. The spray formulation may be a polyurethane or a latex polymer (e.g., styrene acrylic or vinyl acrylic) that are especially easy to spray. The sprayable formulation provides thin effective coatings for shapes that are too complex for molding, for substrates that are not located in a manufacturing environment (e.g., a basement floor in a residence). Unfilled fibers, films, sheets, and moldings can receive a thin coating of 2,6-dinitroaniline-loaded polymer that can protect the shaped object for years from root intrusion. Spray technology also can generate relatively thick slabs that can protect buildings from intrusion by roots and termites.

While the invention has been described with reference to preferred embodiments, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. The following examples show how the invention has been practiced, but should not be construed as limiting. In this application all units are in the metric system and all amounts and percentages are by weight, unless otherwise expressly indicated. Also, all citations referred herein are expressly incorporated herein by reference.

### EXAMPLE 1

### 2,6-Dnitroaniline/Nanoparticle-Loaded Fibers

In preparation for spinning loaded fibers, the 2,6-dinitroaniline-loaded nanoclay was prepared from Dow Agro Science's Treflan® (Trifluralin or TFN) and Nanocor's 1.30P nanoclay. The sorption method of U.S. application Ser. No. 10/816,095 was used. The particle size requirement was that the sample pass through a #60 U.S. Sieve (<250 microns). The product was further ground to about 25-35 micron size. Pelletized polypropylene material was used for the extrusion and spinning of fibers. It was exfoliated by blending the loaded nanoclay with Microthene® polypropylene and extruding the mixture into the melt spinning device. During melt spinning to prepare 77-micron diameter fiber, the platelets became oriented on passing through the spinnerettes.

A geotextile product was prepared by loading the trifuralin/nanoclay/polypropylene fiber material into a polyester matrix that was adjusted to provide between 4 and 8% TFN (w/w) for the first fiber run, and 3% TFN (w/w) for the second test run. These samples were placed in a flow device that exposed the sample to water that contained 0.01% Tween 20. It was operated at room temperature (ca. 23° C.). These conditions are used as an accelerated test in which 24 hours represents 2 or 3 years of exposure in the environment.

Samples run in the accelerated system at 25.5° C. utilized a 2-hour extraction in 10% MeOH to remove external TFN residing on the outside of the fibers. Results were gathered for some 28 days. Steady state (relatively constant release rate) was attained in about 6 days. Extractions to determine total TFM were done on three samples that were the 40% and 60% battings, and the feed fiber containing the TFN at 3.3% initial loading. The Bat-40 has 40% (w/w) of the TFN treated fiber, with the balance polyester fiber, while the Bat-60 has 60% (w/w) treated fiber. All calculations are based on these values, along with the actual TFN remaining in the fiber after production.

The release rates for the TFN-loaded nanoclay filled polypropylene fibers ranged from 1 μg/cm²/day to 3 μg/cm²/day. These fiber release rates compare favorably with those obtained with films and sheets containing TFN-loaded nanoclay, as shown in Table 2 in Example 2.

This is a quite surprising result because the diffusion path from the reservoir to the surface is much less for a fiber than for the injection molded sheets made for comparison purposes. One hypothesis for these results is that the spinning process orients the individual platelets into a single file of particles that lay flat along the axis of the cylindrical fiber. This orientation maximizes the diffusion path to the surface. Also, there may be interaction between the clay particles and the polypropylene matrix that would reduce the void volume of the matrix. This phenomenon is well known in nanoclay science, due to observations that oxygen and other gases diffuse more slowly in polymer films when the films contain the same types of nanoclays as used in this example. However, the phenomenon may be accentuated in thin fibers, compared with films.

Loading Rates

Extractions of the three TFN configurations described above were undertaken in triplicate. The TFN feed fiber contained 23.3±1.5 mg TFN/gm fiber, or 2.3% TFN. The feed material initially contained 8% TFN/nanoclay, or 3.3% TFN. This loss is consistent with the losses noted at the extrusion die during preparation of the samples.

Longevity Estimates

Table 1 provides the tabulation of pertinent data used in the longevity estimates. Note that longevity estimates are based on recovered TFN in the total battings and not just the TFN fiber in the battings. Thus, we anticipated that some TFN would migrate into the polyester fibers in the batting. The release rate is a function of diffusion of TFN from the near fiber surface to the receiving solution or soil. Any accumulation of TFN adjacent to or on the surface of the treated fiber, results in a slowing of the release rate, and a subsequent increase in longevity. In our accelerated extraction/perfusion systems, we try to maximize release by carrying TFN away from the solution/fiber interface. This gives us, in effect, a zero order release rate; or in our case the worst case/highest possible release rate and lowest longevity. In this instance, the test ran for about 30-days at 78° F.

All samples showed an increased release rate with contact with fresh solution, then rapidly settled down to a much lower steady state value at day 2, 3, etc. This appears to involve the expected diffusion feedback based on concentration of TFN at the fiber surface. What is surprising is that the TFN at the surface of the fiber is removed so thoroughly by the fresh solution, while the solution is so much less effective in removing TFN after the first day.

In Table 1, the TFN concentration in the fiber and batting samples is tabulated by extracting them as a unit. These indicate an approximately 30% loss of TFN in the extrusion/spinning process. All longevity estimates include this loss. Any decrease in this loss rate will increase longevity proportionately.

The calculated longevities are tabulated as maximum, nominal, and minimum. The minimum estimated are based on the zero time-release rates (highest) and uncorrected for external build-ups of TFN as discussed above. Corrected longevities are tabulated in parentheses. The nominal and maximum longevities are based on 3- and 12-day accumulations of TFN within the perfusion solutions. The release rates actually decrease, increasing calculated longevity. Based on 25 years of prior work with these systems, our best estimate of longevity lies somewhere between the maximum and nominal values, and are consistent with 15 year longevity, at 78° F.

TABLE 1
Parameters and Estimates Related to TFN-Containing Samples

| % TFN | | | Longevity (years) | | |
|---|---|---|---|---|---|
| Sample | Calculated | Actual | Maximum | Nominal | Minimum |
| TFN Fiber | 3.3 | 2.3 ± 1.5 | 8.2 | 6.4 | 2.1 (5.3) |
| Bat-40 | — | 0.97 ± 0.1 | 12.1 | 10.7 | 4.1 (10.2) |
| Bat-60 | — | 1.4 ± 0.05 | 14.1 | 12.3 | 4.2 (10.5) |

An unexpected observation in these data is the relative behavior of the fiber with and without batting. Bat-40 and Bat-60 contain batting, while TFN Fiber does not. The calculated longevities of the fiber alone was expected to be close to the fiber/batting samples. But the longevities consistently run low with respect to longevity (higher release rate). The batting is acting as a secondary reservoir that receives part of the TFN that is released from the TFN fiber and stores it for later release.

These data support that the 2,6-dinitroaniline-loaded nanoclay particles provide excellent release rates and longevities that are needed to prevent root intrusion. This goal is attained without great detriment to the mechanical properties needed for geotextile applications. This performance is in contrast to the properties of ordinary fibers that are loaded with solids. In addition, feasibility has been shown for use of fiber blends that have TFN fibers that spread their TFN to neighboring fibers to improve resistance to root intrusion. Thus, TFN can be stored in polyethylene terephthalate polyester fibers without having to expose the trifluralin to the high temperature needed for melt spinning of this polymer.

The color of the fiber product is adjusted to meet design specifications for the intended application by colorization of the melt that is used for the spinning operation. A black or green or brown dye is selected.

### EXAMPLE 2

Trifluralin/Nanoparticle-Loaded Film and Sheet Holding Capacity

Trifluralin was preheated above its melting point and slow-blended into preheated clay or nanoclay, using the procedure detailed in U.S. patent application Ser. No. 10/816,095. The results are recorded in Table 2.

TABLE 2
Trifluralin-Loaded Clay Holding Capacity

| | INTER- | | |
|---|---|---|---|
| CLAY or | CALATING | HOLDING | |
| NANOCLAY | AGENT | CAPACITY⁽¹⁾ | STATUS |
| Bentonite | None | 0.41 | Good mix; swells |
| Clay | | | |
| Nanocor N | Dihydroxyethyl | 0.39 | Good mix; swells |
| I.34TCN | Ditallow | | |
| | Ammonium | | |
| Nanocor N | Dimethyl | 0.37 | Good mix; swells |
| I.44PA | di(C14-C18) | | |
| | alkyl | | |
| | Ammonium | | |
| Nanocor N | Octadecylamine | 0.46 | Good mix; swells |
| I.30E | | | |
| Nanocor N | Octadecylamine | 0.42 | Good mix; swells |
| I.30P | | | |
| Nanocor | None | 0.44 | Liquid on surface |
| PGV | | | |
| (Montmorillonite | | | |
| clay) | | | |

⁽¹⁾Gm active/(gm active + clay) (e.g., 1/1 = 0.5, 2/1 = 0.66, 3/1 = 0.75, 4/1 = 0.8)

The three ammonium salts that were used to make the loaded products differ in their chemical structures, but all have hydrophobic groups attached to a nitrogen atom that carries a positive charge. Protonated octadecylamine has one long alkyl chain and three hydrogen atoms attached to the nitrogen atom. Dihydroxyethyl ditallow amine has two long alkyl chains and two short chains that terminate in hydroxy groups attached to the nitrogen atom. Dimethyl di(C₁₄-_{C18)}alkyl amine has two long chains and two short chains attached to the nitrogen atom.

Despite the differences in structure, all of these clays and nanoclays have about the same holding capacity for trifluralin±10%. All of them mix well with molten trifluralin. The swelling indicates that trifluralin expands the clay galleries.

Release Rates

The trifluralin-loaded clays were dispersed in molten polyethylene and polypropylene and injection molded into sheets, as described in U.S. patent application Ser. No. 10/816,095. A flow device was employed to measure the release rates of trifluralin from these composite materials. A summary of these data is shown in Table 3.

TABLE 3
Release Rates Of Trifluralin-Loaded Clays

| | | RELEASE RATE |
|---|---|---|
| SAMPLES | CLAY* | (μG/CM²/DAY) |
| Polyethylene (MA 778-000) | ATTP | 17.49 |
| Polyethylene (MA 778-000) | PGV | 12.5 |
| Polyethylene (MA 778-000) | N I.44PA | 11.47 |
| Polyethylene (MA 778-000) | N I.30P | 7.73 |
| Polypropylene (MU 763-00) | N PGV | 0.9 |
| Polypropylene (MU 763-00) | NI.44PA | 1.07 |
| Polypropylene (MU 763-00) | N I.30P | 0.41 |

*ATTP is attapulgite, a clay that swells well and is used in fertilizer formulations. Nanocor's PGV is a montmorillonite produced by purification of bentonite. The other clays are the reaction products of montmorillonite with aliphatic ammonium salts. They are called nanoclays.

The release rate of trifluralin-loaded attapulgite clay is much higher than the other products, because this clay has a needle structure instead of the platelet structure of the montmorillonite clay product. The lowest release rates by far in the two polymer systems were obtained with Nanocor's I.30P. It is noteworthy that montmorillonite clay has release rates that rival the release rates for the much more expensive I.44PA product made from dimethyl di(C₁₄-C₁₈)alkyl ammonium salt reaction with montmorillonite. We hypothesize that trifluralin is able to intercalate montmorillonite without need for ammonium ion pretreatment because trifluralin's structure has two polar nitro groups and an amino group.

The release rates from polypropylene were 11 to 19 times lower than release from polyethylene. Thus, both the structure of the clay component and the polymer matrix material are important in determining the release rates. These parameters can be manipulated to control the release of trifluralin to meet end use requirements.

The color of the film or sheet product is adjusted to meet design specifications for the intended application by colorization of the melt that is used for the extrusion operation. A black or green or brown dye is selected.

### EXAMPLE 3

### Spray Coating with Trifluralin-Loaded Nanoparticles

In preparation for spraying trifluralin-loaded coatings, trifluralin-loaded nanoclay was prepared from Dow Agro Science's Treflan® trifluralin and Nanocor's I.30P nanoclay. The sorption method of U.S. patent application Ser. No. 10/816,095 was used. The particle size requirement was that the initial output pass through a #60 U.S. Sieve (<250 microns). The initial product was then ground and sieved to obtain particles that are less than 35 μM.

Rhino Linings, Inc.'s Tuff Stuff® sprayed-on polyurethane coating formulations that have the correct performance characteristics was selected for spray application. Its characteristics are 100 percent solids (therefore, no volatile organic solvent problems), cures in less than 10 minutes, has excellent longevity even in outdoor applications, and has excellent impact and abrasion resistance.

Rhino's spraying equipment has a single motor driving two separate fixed-ratio proportioning pumps. These pumps deliver Part A (an isocyanate component) and Part B (a polyol component) separately into a static mixing tube for airless spray operation for coating applications. Transfer efficiency of the equipment is 99%.

The coating can be sprayed onto the substrate that can be a geotextile or other fabric. It also can be applied to concrete, wood, or soil surfaces to prevent intrusion of roots.

The thickness of the thermoplastic elastomer coating can range from 1-mil films to 0.5-inch slabs. The Rhino device could be modified to deliver the reservoir component intermittently in thick coatings, so that the product would be more economical, and the longevity could be fine-tuned.

This procedure also was effective when polymerization of the mixture was conducted-in a casting mode. Thus, 19 gm of part B was blended with one gram of trifluralin-loaded nanoclay. The loading of TFN was 40% in Nanocor's I.30 P. Then, 10 gm of Part A was added and the mixture was cast. This mixture set up within 2 minutes when Parts A and B were blended by hand. The product had a calculated longevity of 36 years, using a release rate of one μg/cm²/day.

The color of the spray product is adjusted to meet design specifications for the intended application by colorization of the mixture that is used for the spraying operation. A black or green or brown dye is selected.

### EXAMPLE 4

### Acrylamide Gel Incorporating Trifluralin-Loaded Nanoparticles

A series of studies were undertaken with acrylamide gels with Nanocor I.30 P clays, and determine the efficacy of these formulations in lining of sewer pipes to prevent plant root intrusion.

Acrylamide gels were prepared from acrylamide, methylene bisacrylamide, sodium persulfate, and inhibitors. The gels were cast into cylinders with a surface area of 12.92 cm². Each 12.92 cm² cylinder was loaded with 0.125 gm TFN contained in 0.172 gm clay. The TFN/clay was mixed into 1 ml of the acrylamide, and stirred. One drop of 0.1% Tween 20 (a wetting agent), helped in particle dispersion. The crosslinking catalyst was added (1 mL), the mixture was stirred, and gelled. The crosslinked product is known as a “polyacrylimide). The dispersion of TFN/clay particles was uniform. The cylinders were removed from the casting cups, and placed into the perfusion system, which contained 0.1% Tween 20 in water, and assayed periodically for release rates.

The perfusion solution used (with wetting agent) increases the water solubility of the TFN from a nominal 0.2 ppm to approximately 100 ppm. This is done to accelerate TFN removal rates from the treated samples.

Table 4 provides the study results and the calculated performance estimates.

TABLE 4
Performance Results for the Acrylamide Gel Systems
Containing Nanocor 1.30P

| Longevity | | |
|---|---|---|
| Configuration | Release Rate-Max | Release Rate-Expected |
| (years) | (μg/cm²) | (μg/cm²) |
| TFN Load-6% | | |
| Perfusion w/max solubility | 0.8 | 33 |
| Perfusion w/water alone | 0.6 | 66 |
| Calculated Application | | |
| Behavior | | |
| 59% duty cycle | | |
| 20% detergent cycle | 0.6 | 50 |
| TFN Load-2% | | |
| Water alone | 0.4 | 22 |
| Sewage conditions | | |
| 59% duty cycle | | |
| 20% detergent cycle | 0.6 | 14 |

The longevity of the 6% loaded treatments were determined to be 33 years from the maximum TFN dissolution system, and 66 years based on adjustments for water solubility in the absence of wetting agents. Both of these values are based on cylinders and not the expected sheet configuration typical of a lining where losses would be expected to be less due to reduced surface area to volume.

In practice, the conditions within a sewer line are variable, there are periods where no water flows, and in this case TFN losses are reduced. On the other hand, there are instances in which detergents flush through and release rates increase. Any number of scenarios can be run, but all are based on reservoir size, TFN content, and the base release rates per unit area; the latter are pretty much fixed. The variable that helps to our advantage is that volatility losses to air are expected to be lower due to the limitations in water solubility, thus water flow is the driver for this system. If the TFN loading rate is reduced to 2% rather than the 6% used, the reservoir size is reduced, and projected longevities decrease to 14-22 years.

The color of the gel product is adjusted to meet design specifications for the intended application by colorization of the reaction mixture that is used for the gelling operation. A black or green or brown dye is selected.

The experiment described above provided desirable longevity results. However, this method allows 2,6-dinitroaniline to be exposed to the free radicals that catalyze the polymerization of acrylamide and its crosslinking reactions. It is likely that some of the 2,6-dinitroaniline will be destroyed by reacting with the catalyst and that the polymerization/crosslinking reactions may be impaired.

The improvement provided in this invention is that the 2,6-dinitroaniline source be encapsulated within polypropylene or polyethylene fibers. The formulation would include the fibers and the usual ingredients for polyacrylamide gel products. The polymerization and crosslinking reactions would not affect the 2,6-dinitroaniline. Thus, a stronger gel and a higher concentration of 2,6-dinitroaniline are expected.

Layered 2,6-Dinitroaniline/Nanoparticle-Loaded Composites

Many current state-of-the-art sustained release devices are made by dispersion of the active ingredient in a fluid polymer matrix (molten or solution), followed by conversion to a solid shaped object. This approach encounters technical and/or economic problems when the polymer has a high melting point or is sparingly soluble in solvents. This obstacle may be overcome by making multilayer composites in which the active ingredient is dispersed in a convenient fluid polymer that provides a film or sheet shape. This film/sheet then is adhered to other polymer layers that control release of the active ingredient. This approach also faces economic challenges, as well as technical problems.

The 2,6-dinitroaniline-loaded nanoclay reservoirs of this invention provide an improvement over the current state of the art through rendering feasible a variation on powder coating technology. The 2,6-dinitroaniline-loaded nanoclay particles are ground to a size range that is suitable for the end use application, usually about 20 μM or less to 75 μM. The particles are sprayed onto a substrate (film or sheet or more complex shape) using an electrostatic spraying device. For polymer matrices, a second layer can be applied to make a sandwich with the trifluralin-loaded nanoclay reservoirs trapped between the two polymer layers. These two layers can be welded together by pressing through nip rolls that are optionally heated. One or both of the layers can be made of fiber mats that are intermediates in the manufacture of nonwoven fabrics.

The 2,6-dinitroaniline-loaded nanoclay reservoirs do not have to be evenly distributed on the surface of the first polymer. They can be applied as a pattern that imparts the desired level of root-intrusion repellency and the desired longevity. This approach does not always require electrostatic spray technology. The 2,6-dinitroaniline-loaded nanoclay reservoirs can be delivered to the first surface by simple gravity feed onto a moving bed or by passing the substrate layer through rolls that dispense the 2,6-dinitroaniline-loaded nanoclay reservoirs and then compacts them.

The color of the geotextile product is adjusted to meet design specifications for the intended application by colorization of the top and bottom sheets. A black or green or brown dye is selected.

We claim:

1. An active control device for control of one or more of root intrusion or plant growth, which comprises:
a fiber formed in the presence of and containing an exfoliated nanoclay retaining an ammonium ion chemical having 6 or more carbon atoms and loaded with a 2,6-dinitroaniline.

2. The active control device of claim 1, wherein said fiber was formed by one or more of melt spinning in the presence of said exfoliated nanoclay or by film-to-fiber processes in which an intercalated nanoclay containing a 2,6-dinitroaniline is exfoliated in a polymer melt and extruded to form a film that is one or more of slit or chemomechanically fibrillated, and twisted to form fibers.

3. The active control device of claim 1, wherein said 2,6-dinitroaniline comprises one or more of trifluralin, oryzalin, pendimethalin, isopropalin, diniramine, fluchloralin, benefin, dinoseb, or a salt thereof.

4. The active control device of claim 1, wherein exfoliated nanoclay comprises one or more of smectite, bentonite, montmorillonite, beidellite, nonttronite, saponite, or sauconite.

5. The active control device of claim 3, wherein exfoliated nanoclay comprises one or more of smectite, bentonite, montmorillonite, beidellite, nonttronite, saponite, or sauconite.

6. The active control device of claim 1, wherein said fiber comprises a thermoplastic comprising one or more of polypropylene, polyethylene, ethylene/propylene copolymers, polyethylene terephthalate, polytrimethylene terephthalate, polyamides, polycaprolactone, polylactic acid, lactic acid-glycolic acid polyesters, or poly(3-hydroxy butyrate).

7. The active control device of claim 5, wherein said fiber comprises a thermoplastic comprising one or more of polypropylene, polyethylene, ethylene/propylene copolymers, polyethylene terephthalate, polytrimethylene terephthalate, polyamides, polycaprolactone, polylactic acid, lactic acid-glycolic acid polyesters, or poly(3-hydroxy butyrate).

8. The active control device of claim 1, which has been formed into one or more of a woven or nonwoven fabric.

9. The active control device of claim 8, wherein said fabric is woven from a mixture of the fibers of claim 1 and fibers devoid of said 2,6-dinitroaniline.

10. The active control device of claim 3, which has been formed into one or more of a woven or nonwoven fabric.

11. The active control device of claim 5, which has been formed into one or more of a woven or nonwoven fabric.

12. The active control device of claim 7, which has been formed into one or more of a woven fabric, a nonwoven fabric, or sandwiched between sheets of fabric.

13. The active control device of claim 8, wherein fibers devoid of said 2,6-dinitrolaniline comprise fibers of one or more of cotton, rayon, cellulose pulp, flax, jute, hemp, wool, cellulose acetate, a vinyl, or an acrylic.

14. The active control device of claim 1, which is blended with one or more of polymer-forming ingredients or an already formed polymer and formed into one or more of a coating, a caulk, a sealant, or a gasket.

15. The active control device of claim 14, wherein said polymer comprises one or more of polyurethane, polyethylene, polypropylene, polybutenes, natural rubber, polyisoprene, polyesters, styrene butadiene rubber, EPDM, polyacrylates, polymethacrylates, polyethylene terephthalate, polypropylene terephthalate, nylon 6, nylon 66, polylactic acid, polyhydroxy butyrate, polycarbonate, epoxy resins, or unsaturated polyester resins.

16. A method for forming a fiber useful in forming a control device for control of one or more of root intrusion or plant growth, which comprises:
forming a fiber in the presence of an exfoliated nanoclay retaining an ammonium ion chemical having 6 or more carbon atoms and loaded with a 2,6-dinitroaniline, whereby said formed fiber retains said loaded nanoclay.

17. The method of claim 16, wherein said fiber was formed by one or more of melt spinning in the presence of said exfoliated nanoclay or by film-to-fiber processes in which an intercalated nanoclay containing a 2,6-dinitroaniline is exfoliated in a polymer melt and extruded to form a film that is slit and twisted to form fibers.

18. The method of claim 16, wherein said 2,6-dinitroaniline comprises one or more of trifluralin, oryzalin, pendimethalin, isopropalin, diniramine, fluchloralin, benefin, or dinoseb.

19. The method of claim 16, wherein exfoliated nanoclay comprises one or more of smectite, bentonite, montmorillonite, beidellite, nonttronite, saponite, or sauconite.

20. The method of claim 18, wherein exfoliated nanoclay comprises one or more of smectite, bentonite, montmorillonite, beidellite, nonttronite, saponite, or sauconite.

21. The method of claim 16, wherein said fiber comprises a thermoplastic comprising one or more of polypropylene, polyethylene, ethylene/propylene copolymers, polyethylene terephthalate, polytrimethylene terephthalate, polyamides, polycaprolactone, polylactic acid, lactic acid-glycolic acid polyesters, or poly(3-hydroxy butyrate).

22. The method of claim 20, wherein said fiber comprises a thermoplastic comprising one or more of polypropylene, polyethylene, ethylene/propylene copolymers, polyethylene terephthalate, polytrimethylene terephthalate, polyamides, polycaprolactone, polylactic acid, lactic acid-glycolic acid polyesters, or poly(3-hydroxy butyrate).

23. The method of claim 16, which has been formed into one or more of a woven or nonwoven fabric.

24. The method of claim 23, wherein said fabric is woven from a mixture of the fibers of claim 1 and fibers devoid of said 2,6-dinitroaniline.

25. The method of claim 18, which has been formed into one or more of a woven or nonwoven fabric.

26. The method of claim 20, which has been formed into one or more of a woven or nonwoven fabric.

27. The method of claim 22, which has been formed into one or more of woven fabric, a nonwoven fabric, or sandwiched between sheets of fabric.

28. The method of claim 23, wherein fibers devoid of said 2,6-dinitrolaniline comprise fibers of one or more of cotton, rayon, cellulose pulp, flax, jute, hemp, wool, cellulose acetate, a vinyl, or an acrylic.

29. The method of claim 16, which is blended with one or more of polymer-forming ingredients or an already formed polymer and formed into one or more of a coating, a caulk, a sealant, or a gasket.

30. The method of claim 29, wherein said polymer comprises one or more of polyurethane polymer, polyethylene, polypropylene, polybutenes, natural rubber, polyisoprene, polyesters, styrene butadiene rubber, EPDM, polyacrylates, polymethacrylates, polyethylene terephthalate, polypropylene terephthalate, nylon 6, nylon 66, polylactic acid, polyhydroxy butyrate, polycarbonate, epoxy resins, or unsaturated polyester resins.

31. In a method for controlling one or more of root intrusion or plant growth with a control device, the improvement which comprises:
using as said control device, a fiber formed in the presence of an exfoliated nanoclay retaining an ammonium ion chemical having 6 or more carbon atoms and loaded with a 2,6-dinitroaniline, whereby said formed fiber retains said loaded nanoclay.

32. The method of claim 31, wherein said fiber was formed by one or more of melt spinning in the presence of said exfoliated nanoclay or by film-to-fiber processes in which an intercalated nanoclay containing a 2,6-dinitroaniline is exfoliated in a polymer melt and extruded to form a film that is one or more of slit or chemomechanically fibrillated, and twisted to form fibers.

33. The method of claim 31, wherein said 2,6-dinitroaniline comprises one or more of trifluralin, oryzalin, pendimethalin, isopropalin, diniramine, fluchloralin, benefin, or dinoseb.

34. The method of claim 31, wherein exfoliated nanoclay comprises one or more of smectite, bentonite, montmorillonite, beidellite, nonttronite, saponite, or sauconite.

35. The method of claim 33, wherein exfoliated nanoclay comprises one or more of smectite, bentonite, montmorillonite, beidellite, nonttronite, saponite, or sauconite.

36. The method of claim 31, wherein said fiber comprises a thermoplastic comprising one or more of polypropylene, polyethylene, ethylene/propylene copolymers, polyethylene terephthalate, polytrimethylene terephthalate, polyamides, polycaprolactone, polylactic acid, lactic acid-glycolic acid polyesters, or poly(3-hydroxy butyrate).

37. The method of claim 35, wherein said fiber comprises a thermoplastic comprising one or more of polypropylene, polyethylene, ethylene/propylene copolymers, polyethylene terephthalate, polytrimethylene terephthalate, polyamides, polycaprolactone, polylactic acid, lactic acid-glycolic acid polyesters, or poly(3-hydroxy butyrate).

38. The method of claim 31, which has been formed into one or more of a woven or nonwoven fabric.

39. The method of claim 38, wherein said fabric is woven from a mixture of the fibers of claim 1 and fibers devoid of said 2,6-dinitroaniline.

40. The method of claim 33, which has been formed into one or more of a woven or nonwoven fabric.

41. The method of claim 35, which has been formed into one or more of a woven or nonwoven fabric.

42. The method of claim 37, which has been formed into one or more of a woven fabric, a nonwoven fabric, or sandwiched between sheets of fabric.

43. The method of claim 38, wherein fibers devoid of said 2,6-dinitrolaniline comprise fibers of one or more of cotton, rayon, cellulose pulp, flax, jute, hemp, wool, cellulose acetate, a vinyl, or an acrylic.

44. The method of claim 31, which is blended with one or more of polymer-forming ingredients or an already formed polymer and formed into one or more of a coating, a caulk, a sealant, or a gasket.

45. The method of claim 44, wherein said polymer comprises one or more of polyurethane, polyethylene, polypropylene, polybutenes, natural rubber, polyisoprene, polyesters, styrene butadiene rubber, EPDM, polyacrylates, polymethacrylates, polyethylene terephthalate, polypropylene terephthalate, nylon 6, nylon 66, polylactic acid, polyhydroxy butyrate, polycarbonate, epoxy resins, or unsaturated polyester resins.
